(19) United States
(12) Patent Application Publication
(10) Pub. No.: US 2010/0024664 A1
(43) Pub. Date: Feb. 4, 2010

(54) FOOD PREPARATION DEVICE

(76) Inventor: Franck Rolland, Lausanne (CH)

Correspondence Address: NIXON & VANDERHYE, PC, 901 NORTH GLEBE ROAD, 11TH FLOOR, ARLINGTON, VA, 22203, US

(21) Appl. No.: 12/439,743

(22) PCT Filed: Sep. 5, 2007
(86) PCT No.: PCT/IB07/53569

§ 371 Date: Apr. 14, 2009

(30) Foreign Application Priority Data
Sep. 5, 2006 (CH) 01423/06

(51) Int. Cl. A23P 1/00

(52) U.S. Cl. 99/450.6

(57) ABSTRACT

The device comprises at least two shells whose inside has a cylinder-shaped part and a movable flexible element designed to turn the food in said shells when the shells are assembled to form a device whose inside is of a generally cylindrical shape.

The present invention relates to a rolled food preparation device, for example maki sushi, or other food or products of similar design.

In order to explain better the device of the present invention, an example used for the preparation of maki sushi will be described, but it goes without saying that this example is not limiting and that other foods or products may be perfectly prepared by means of the device according to the invention.

As is known, maki sushi consists mainly of rice, and of raw fish and/or vegetables, all of this being wrapped in a seaweed sheet and having a generally cylindrical form.

For the preparation of maki sushi it is therefore necessary to put the rice and the other ingredients on the seaweed sheet and to roll it. As the seaweed sheet is very thin, this operation is difficult to carry out without tearing the sheet; similarly, it is equally difficult to prepare maki sushi having a good cylindrical form.

The aim of the invention is thus to overcome these problems by means of a simple device that is cheap and easy to use.

The invention will be better understood with the help of the description of an embodiment and the appended figures, in which:

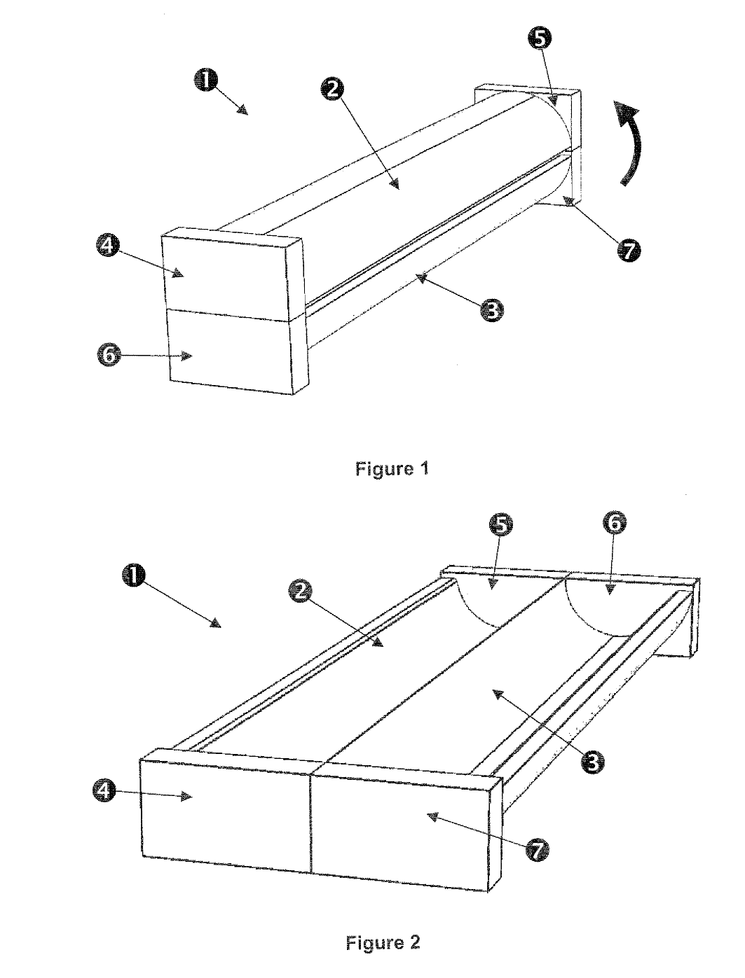

FIG. 1 shows a perspective view of the closed device according to the invention;

FIGS. 2 to 5 show a perspective view of the open device according to the invention;

FIG. 6 shows a perspective view of the closed device according to the invention;

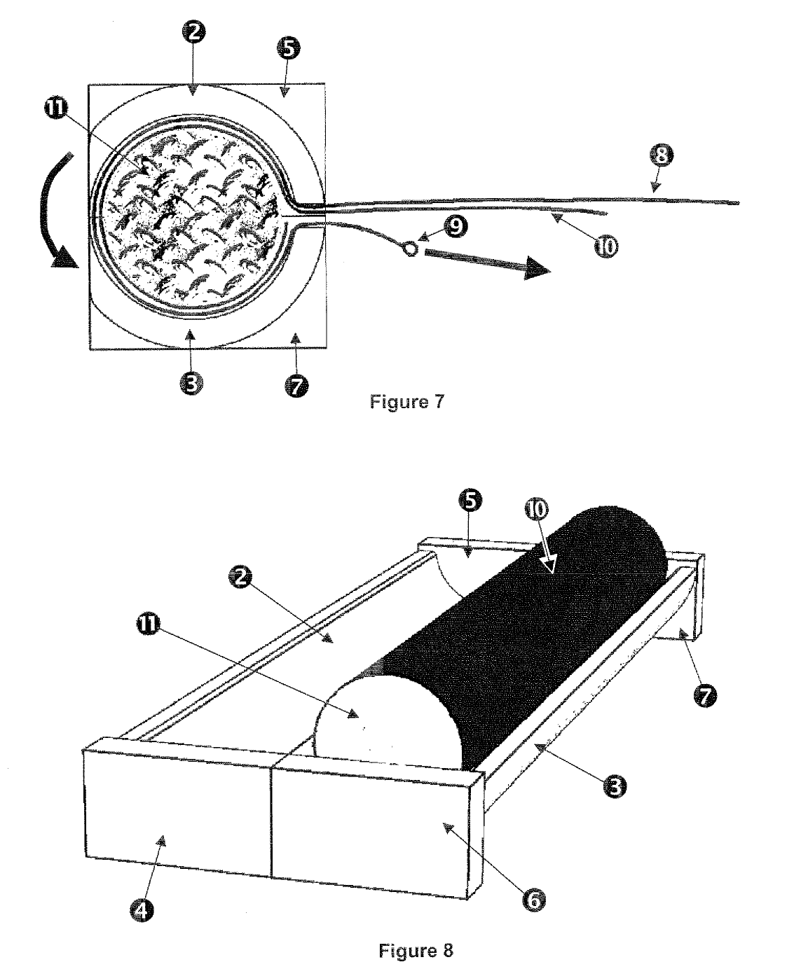

FIG. 7 shows a sectional view of the closed device according to the invention; and

FIG. 8 shows a perspective view of the open device according to the invention with prepared food.

FIG. 1 shows the device 1 according to the invention in a closed position. It comprises two shells 2, 3 in the form of parts with a cross section that is (preferably, but not necessarily) partly circular, which parts are preferably (but not necessarily) hinge joined to one another by means of hinges (not shown). Each shell 2, 3 is preferably closed at each of its ends by a plate 4, 5, or 6, 7 respectively, preferably of a generally rectangular shape. Another shape is of course conceivable. These plates are not indispensable and they may be omitted or replaced by another equivalent means.

In FIG. 2, the device 1 is shown in the open state, thus showing the interior surfaces of the two shells 2, 3 which have a hollow form.

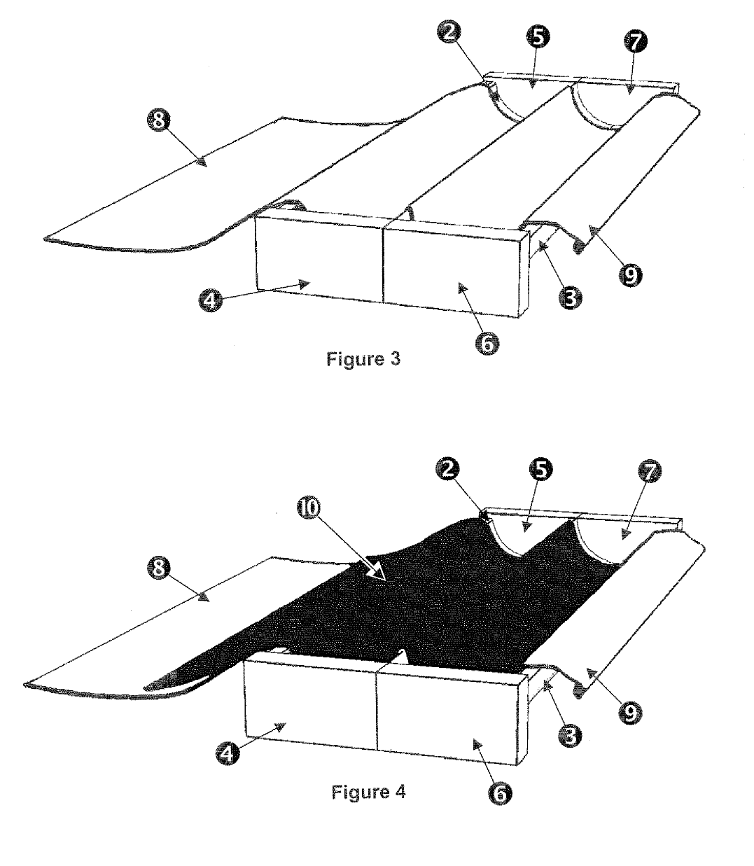

In FIG. 3, the device is shown in the open state in which a flexible element in the form of a film made of plastic 8, used for preparing the food, is positioned. Optionally, the film 8 might comprise, at one of its ends, a bulge 9, the use of which will be explained further below.

In order to prepare maki sushi a seaweed sheet 10 is placed in the device of FIG. 3. As shown in FIG. 4, the edge of the seaweed sheet on the right side of FIG. 4 is approximately aligned with the edge of the shell 3, while the edge of the sheet on the left side of the figure extends beyond the shell 2.

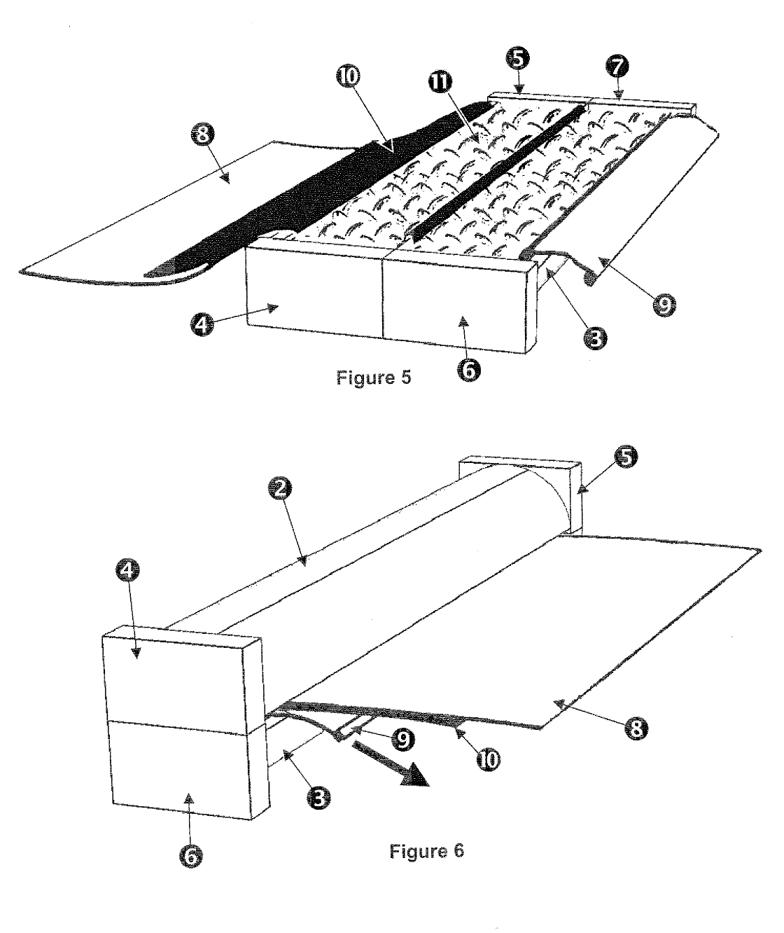

As shown in FIG. 5, the device 1 is then loaded with the food that is intended to be wrapped in the seaweed sheet, for example rice, raw fish and/or vegetables, thus forming the food parts 11 in each shell 2, 3.

Once loaded in the desired manner, the two shells 2 and 3 are closed as shown in FIG. 6, and the film 8 is pulled on by means of the bulge 9, as indicated by the arrow in FIG. 6. FIG. 7 is a cross section of the device of FIG. 6 which allows the operation to be understood better. Thus by pulling on the film 8 the seaweed sheet 10 and the food to be wrapped 11 are rotationally driven by friction, which makes it possible to “roll” these inside the sheet 10 and to obtain the result shown in FIG. 8, prepared food which has the form of a cylinder. As can be seen clearly in FIG. 7, it is necessary to provide a slot between the shells 2, 3 when they are closed so as to allow the film 8 to pass and be extracted.

Of course, the invention is not limited to the preparation of maki sushi; rather other wrapped foods, or even other products, may be made by means of the device according to the invention. It is possible, for example, to replace the seaweed sheet by a pancake or another food product which has the form of a sheet in which other ingredients are placed.

The two shells may or may not be hinge joined to one another. If they are not hinge joined, it is possible to provide fixing means enabling one to be fixed to the other (by interlocking, according to the principle of a male part interacting with a female part, for example). By way of example, the hinge or interlock means may be located on the plates 4-7.

Similarly, it is possible to do without plates positioned at the ends of the shells. In this case, it may be simpler, when using the device, to place it vertically in order to prepare the product, one of the ends being closed by the surface on which the product is prepared. In addition, in the absence of plates 4-7 the hinge or interlock means will preferably, but not limitingly, be located on the shells 2, 3.

The flexible element may be formed by a film, a cloth, or by any other equivalent means.

The hollow interior part of the shells may have a generally cylindrical or oval form, or any other suitable shape.

As will be understood, the device of the invention is very simple, can be manufactured at low cost, and may be used by private individuals or professionals.

The device may be manufactured from any suitable material, for example from wood, from plastic, from metal, or even from a combination of materials, and it may be used to prepare food as described above or any other food or non-food product.

On the other hand, the invention is not limited to the embodiments described, which form illustrative examples, and equivalent means are conceivable.

1. A device for food preparation comprising at least two shells, the interior of which is in the form of a part cylinder and a movable flexible element designed to rotationally drive food products situated in said shells when they are assembled.

2. The device as claimed in claim 1, in which the movable flexible element is a film made of plastic.

3. The device as claimed in claim 1, in which the two shells are hinge joined to one another.

4. The device as claimed in claim 1, in which the two shells interlock with one another.

5. The device as claimed in claim 1, in which the shells comprise a closing plate at each end.

6. The device as claimed in claim 5, which is hinge joined by the closing plates.

7. The device as claimed in claim 1, characterized in that it is made from wood, or from plastic, or from metal, or from a combination of these materials.

8. A method for preparing food using the device as claimed in claim 1, said method comprising the following steps:
the two shells are placed side by side;
the movable flexible element is positioned in the two shells, with at least one end of the flexible element jutting out from one of the shells;
the food products are placed on the flexible element in each shell;
the shells are closed;
the part of the flexible element that juts out is pulled while keeping the device in the closed position, rotationally driving the food products placed in the shells; and
the device is opened to remove the food products.

9. A device for implementing the method of claim 8.
